(19) United States
(12) Patent Application Publication
(10) Pub. No.: US 2010/0274839 A1
(43) Pub. Date: Oct. 28, 2010

(54) Updating system for word banks and the method thereof

(75) Inventors: Chaucer Chiu, Taipei (TW); Xiao Yan Xu, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/453,017

(22) Filed: Apr. 28, 2009

(51) Int. Cl. G06F 15/16

(52) U.S. Cl. 709/203

(57) ABSTRACT

An updating system for word banks and the method thereof are disclosed. The invention transmits a request list containing a word bank number and the corresponding word status from a user end to a server end. After a comparison, the server end extracts an update file and transmits it to the user end for it to update its word bank. The words can thus be updated by providing a word bank number and the corresponding word status. This prevents the situation of being unable to update a word bank because two or more word banks use the same language.

### BACKGROUND OF THE INVENTION

1. Field of Invention

The invention relates to an updating system for word banks and the method thereof. In particular, the invention relates to an updating system and method that update a word bank by providing a word bank number and the corresponding word status.

2. Related Art

With the advances in information technology and Internet and the trend in global village, people start to receive information from all over the world. Modern life of human beings is bombarded with information from television, books, newspapers, magazines, and the Internet. The chances that each person encounters foreign languages are increasing. Because of this, it becomes a trend for people to learn a second or even third foreign language.

When learning a foreign language, a dictionary is often needed for looking up new words. Such an activity has improved from traditional paper dictionaries to translator machines. Since nowadays people use computers everyday, there are translating programs for users to look up words. The translating software includes word banks of various languages, such as Chinese-English word bank, Chinese-Japanese word bank, computer word bank, etc. The translating software often needs to update its words, i.e., updating words in the word bank. Traditionally, the words are updated according to the word bank they belong to. This is likely to mix up the word bank or even result in updating errors. For example, suppose a word in the English-Chinese word bank is in English and its interpretations are in Chinese. At the same time, the word in the computer word bank is in English and has Chinese interpretations. Using the above-mentioned method to update the word bank will encounter the question whether an update English word with Chinese interpretations belongs to the English-Chinese word bank or the computer word bank.

In summary, the prior art long has the problem of ambiguity in determining which word bank to update and updating errors. It is thus imperative to provide a solution.

### SUMMARY OF THE INVENTION

In view of the foregoing, the disclosed updating system for word banks includes a user end and a server end. The user end includes a first receiving module, a reading module, a generating module, a first transmitting module, and an updating module. The first receiving module receives an updating command and an updating file. The reading module reads the corresponding word status according to the updating list after receiving the updating command. The generating module uses the corresponding word status of the word bank to generate a request list. The request list includes a word bank number and the corresponding word status of the word bank. The first transmitting module transmits the request list. After receiving the updating file, the updating module updates it to the word bank with the word bank number. The server end includes a second receiving module, a comparing module, an extracting module, and a second transmitting module. The second receiving module receives the request list sent from the user end. The comparing module compares the updating data list according to the request list to obtain an extracting list. The updating data list includes a word bank number and the updating word status in the corresponding word bank. The extracting module extracts updating data according to the extracting list, thereby obtaining the updating file. The updating file has the word bank number and the updating word status. The second transmitting module transmits the updating file to the user end.

The disclosed updating method for word banks includes the following steps. After the user end receives the updating command, it reads the corresponding word status from the word bank according to the updating list. The user end uses the word status in the word bank to generate a request list. The request list includes a word bank number and the corresponding word status thereof. The request list is sent to the server end. The server end compares the request list with the updating data list to obtain an extracting list. The updating data list includes the word bank number and the corresponding word status of the word bank. The extracting list is used to extract updating data, thereby obtaining an updating file. The updating file has the word bank number and the updating word status. The server end then transmits the updating file to the user end. Afterwards, the user end updates the updating file to the word bank with the corresponding word bank number.

A difference between the disclosed system and method and the prior art is in that the invention transmits from the user end a request list containing a word bank number and the corresponding word status to the server end. After a comparison, the server end extracts an updating file and sends it to the user end. The user end then uses the updating file to update the word bank.

Using the above-disclosed technique, the invention achieves the goal of updating words by providing a word bank number and a corresponding word status of the word bank. This prevents the situation of being unable to update a word bank because two or more word banks use the same language.

### BRIEF DESCRIPTION OF THE DRAWINGS

The invention will become more fully understood from the detailed description given herein below illustration only, and thus is not limitative of the present invention, and wherein:

FIG. 1 shows the structure of the disclosed word bank updating system;

FIG. 2 is a block diagram of details in the disclosed system;

FIG. 3 is a flowchart of the disclosed word bank updating method; and

FIGS. 4 to 9 are schematic views showing an embodiment of the disclosed system.

### DETAILED DESCRIPTION OF THE INVENTION

The present invention will be apparent from the following detailed description, which proceeds with reference to the accompanying drawings, wherein the same references relate to the same elements.

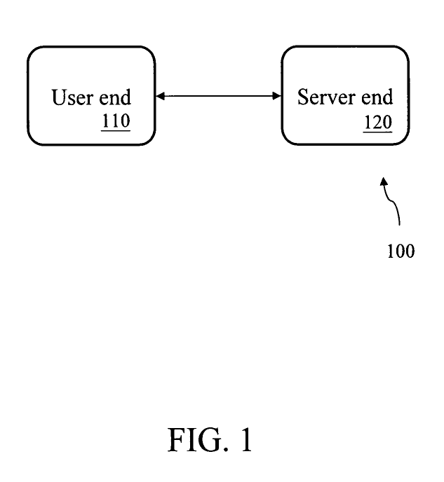

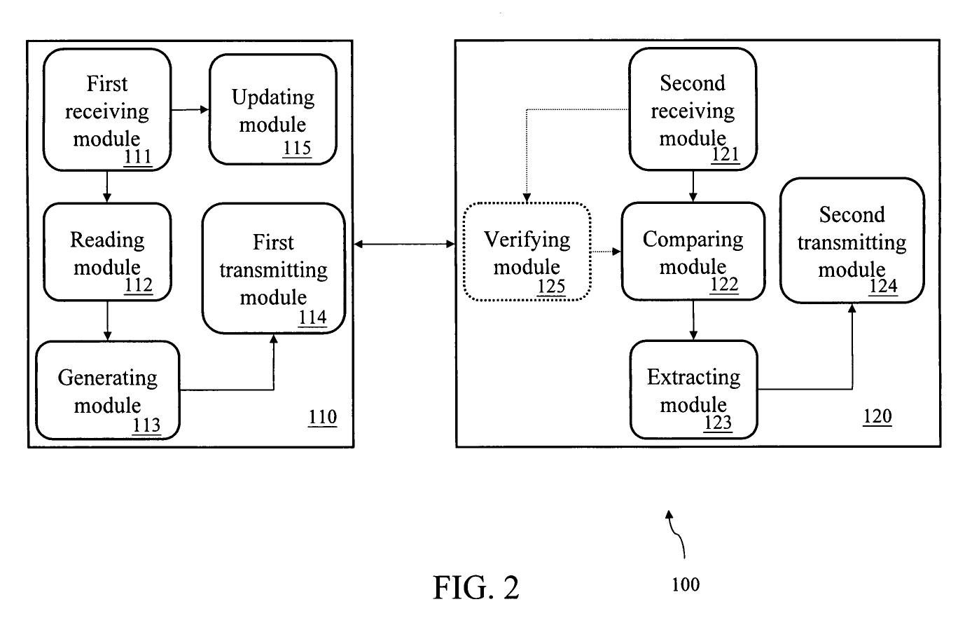

Before describing embodiments of the invention, the disclosed updating system and method for word banks is explained with reference to accompanying figures. FIG. 1 and FIG. 2 are structural and detailed block diagrams of the disclosed updating system for word banks, respectively. The word bank updating system 100 includes a user end 110 and a server end 120. The user end 110 includes a first receiving module 111, a reading module 112, a generating module 113, a first transmitting module 114, and an updating module 115. The server end 120 includes a second receiving module 121, a comparing module 122, an extracting module 123, and a second transmitting module 124.

The user end 110 runs an application program with word banks, such as translation software. After connecting with the server end 120, it updates words in the word banks. The server end 120 is a server that provides information of word bank update to the user end 110, such as the server end of translation software.

The first receiving module 111 receives an updating command and an updating file. The updating command is the updating command sent out from the application program, such as one sent out when the application program starts to regularly at a fixed interval. The first receiving module 111 receives the updating command. The updating command is sent from the server end 120 to the user end 110. The details about how the first receiving module 111 receives the updating file will be described later.

After the first receiving module 111 receives the updating command, the reading module 112 reads the corresponding word status from word banks according to the updating list. The word banks are stored in the application program. Each word bank has a specific word bank number. For example, the “English-Chinese and Chinese-English Word Bank” has a word bank number “11012.” The “Japanese-Chinese and Chinese-Japanese Word Bank” has a word bank number “11013.” The word status describes the updating status of each word bank. For example, suppose the word status of the “English-Chinese and Chinese-English Word Bank” is “3,” it means that the corresponding word bank has been updated to version 3. It should be noted that the updating list defines the word bank that the user or the system wants to update. That is, the user can select a word bank to update and add it into the updating list. Alternatively, the system can select a default word bank to update and add it into the updating list. Therefore, after the first receiving module 111 receives the updating command, the reading module 112 reads the corresponding word statuses of the word banks in the updating list. For example, the reading module 112 obtains that the word status of the “English-Chinese and Chinese-English Word Bank” is “3” and that of the “Japanese-Chinese and Chinese-Japanese Word Bank” is “2.”

The generating module 113 generates a request list according to the word statuses of the word banks. The request list includes word bank numbers and the corresponding word statuses. In other words, after the reading module 112 reads the word statuses of the word banks, the generating module 113 combines the word bank numbers and the corresponding word statuses of all the word banks and generates a request list. In the above-mentioned example, the generating module 113 generates a request list that contains the word bank number “11012” and the word status “3” of the “English-Chinese and Chinese-English Word Bank”, and the word bank number “11013” and the word status “2” of the “Japanese-Chinese and Chinese-Japanese Word Bank.”

The first transmitting module 114 transmits the request list. After the generating module 113 generates the request list, the first transmitting module 114 transmits it to the server end 120 via the connection between the user end 110 and the server end 120.

After receiving the updating file, the updating module 115 updates contents in the updating file to the word banks according to the word bank numbers. The details will be described later.

In the server end 120, the second receiving module 121 receives the request list sent from the user end 110. That is, when the first transmitting module on the user end 110 transmits the request list to the server end 120, the second receiving module 121 receives it.

The comparing module 122 obtains an extracting list by comparing the updating data list according to the request list. The updating data list includes the word bank numbers and the corresponding word statuses. After the second receiving module 121 receives the request list, the comparing module 122 compares the word bank numbers and the corresponding word statuses in the request list with those in the updating data list. After the comparison, the word statuses of the word banks that need to be updated are obtained, thereby obtaining the extracting list. In the above-mentioned example, the comparing module 122 compares the word bank number “11012” and the corresponding word status “3” of the “English-Chinese and Chinese-English Word Bank” and the word bank number “11013” and the corresponding word status “2” of the “Japanese-Chinese and Chinese-Japanese Word Bank” in the request list with the word bank number “11012” and the corresponding word status “4” of the “English-Chinese and Chinese-English Word Bank” and the word bank number “11013” and the corresponding word status “3” of the “Japanese-Chinese and Chinese-Japanese Word Bank” in the updating data list. It obtains the extracting list that the word status of the word bank number “11012” should be updated to “4” and the word status of the word bank number “11013” should be updated to “3.”

The extracting module 123 extracts updating data according to the extracting list, thereby obtaining an updating file. Each updating file has a word bank number and an update word status. That is, after the comparing module 122 obtains the extracting list, the extracting module 123 extracts the updating data according to the extracting list to render an updating file. In the above-mentioned example, the extracting module 123 uses the update word status “4” corresponding to the word bank number “11012” and the word status “3” corresponding to the word bank number “11013” to obtain an updating files “11012-4” and “11013-3,” respectively. The updating file “11012-4” has the word bank number “11012” and the update word status “4”. The updating file “11013-3” has the word bank number “11013” and the update word status “3.”

The second transmitting module 124 transmits the updating files to the user end 110. That is, after the extracting module 123 extracts the updating files, the second transmitting module 124 transmits them to the user end 110 via the connection between the user end 110 and the server end 120. The first receiving module 111 on the user end 110 receives the updating files. In the above-mentioned example, the second transmitting module 124 transmits the updating files “11012-4” and “11013-3” to the user end 110 for the first receiving module 111 on the user end 110 to receive.

After the first receiving module 111 on the user end 110 receives the updating files, the updating module 115 thereof updates the updating files according to the word bank numbers therein to the corresponding word banks. That is, the updating module 115 updates the updating files to the corresponding word banks according to the word bank numbers therein. In the above-mentioned example, the updating module 115 updates the updating file “11012-4” to the corresponding “English-Chinese and Chinese-English Word Bank” as it contains the word bank number “11012.” The updating module 115 also updates the updating file “11013-3” to the corresponding “Japanese-Chinese and Chinese-Japanese Word Bank” as it contains the word bank number “11013.”

It is noted that the updating module 115 on the user end 110 further updates the word statuses corresponding to the word bank numbers to the update word statuses. That is, after the updating module 115 updates the updating files to the corresponding word banks, it further updates the word statuses of word banks according to the word bank numbers in the updating files. In the above example, after the updating module 115 updates the “English-Chinese and Chinese-English Word Bank,” it further changes the corresponding word status from “3” to “4” because the updating file “11012-4” has the update word status “4” for the word bank number “11012.” After the updating module 115 updates the “Japanese-Chinese and Chinese-Japanese Word Bank,” it further changes the corresponding word status from “2” to “3” because the updating file “11013-3” has the update word status “3” for the word bank number “11013.”

Moreover, the request list can also include a serial number. Correspondingly, the server end 120 is added with a verifying module 125 for checking the serial number in the request list. The serial number is used to check whether the application program is a legal copy. Once the verifying module 125 verifies the serial number in the request list, the comparing module 112 on the server end 120 starts the comparison. If the serial number is found to be illegal, the comparing module 112 on the server end 120 refuses to perform the comparison.

Through the above-mentioned operations of the word bank updating system, the user end transmits the request list containing the word bank numbers and the corresponding word statuses of the word banks to the server end. The server end compares and extracts the updating files for the user end. The user end then updates its word banks accordingly. This prevents the problem in the prior art that there might be word bank confusions or updating errors.

In the following paragraphs, the disclosed method is explained with reference to an explicit embodiment. However, it is not used to restrict the scope of the invention. Any person skilled in the art can make obvious modifications based on the spirit of the invention.

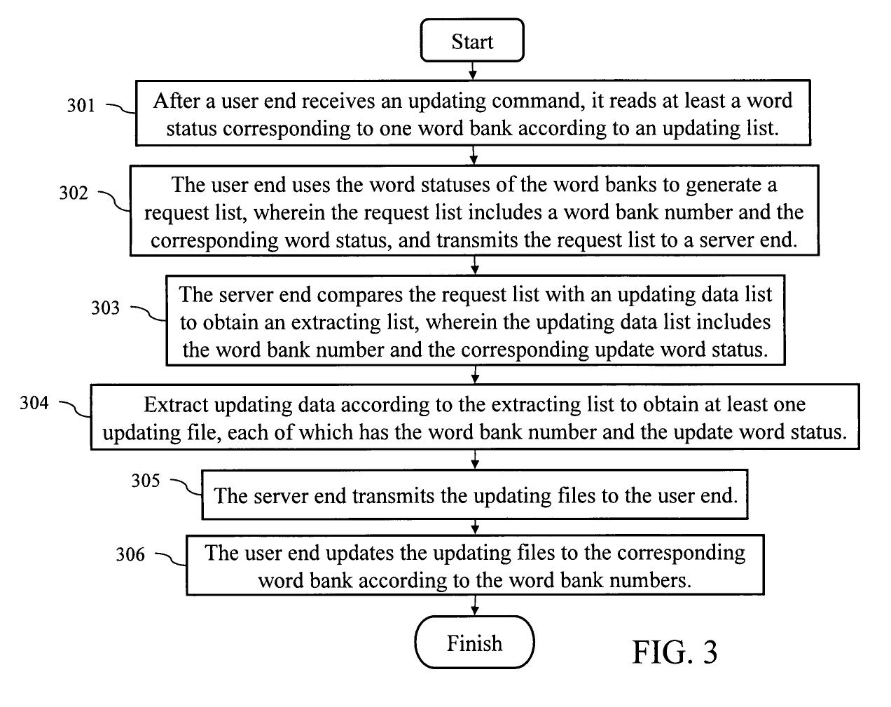

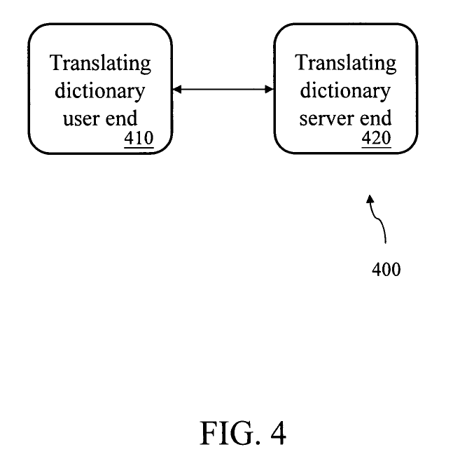

FIG. 3 is a flowchart of the disclosed word bank updating method. FIGS. 4 to 9 are schematic views of an embodiment of the invention. Please refer to FIGS. 3 to 9 in the following description of steps in the disclosed method.

This embodiment uses a translating dictionary program as an explicit example. In this case, the user can use the service of updating words in the translating dictionary program. That is, after the user starts the translating dictionary, he can use the disclosed word bank updating system to update words in the word banks thereof.

Please refer to FIG. 4. The translating dictionary updating system 400 includes a translating dictionary user end 410 (i.e., the user end) and a translating dictionary server end 420 (i.e., the server end). After the user starts the translating dictionary, the translating dictionary user end establishes a connection with the translating dictionary server end 420 via a network for real-time updates.

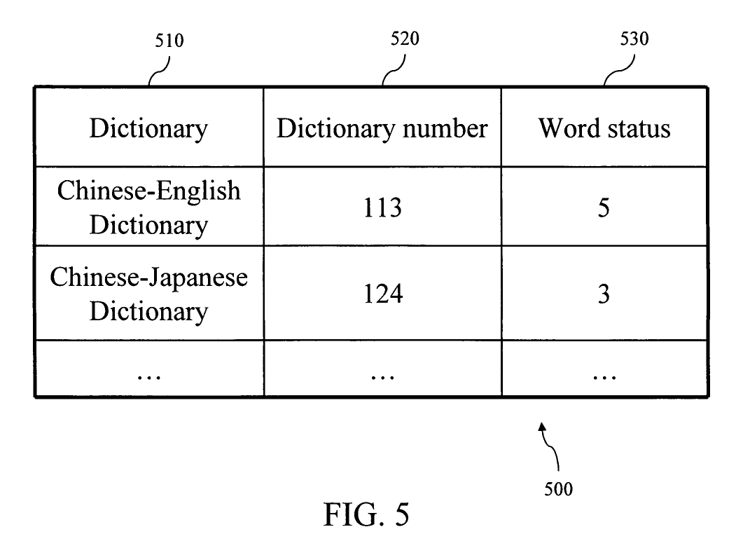

Please refer to FIG. 5. The dictionary list 500 includes dictionaries 510 (i.e., the word banks), dictionary numbers 520 (i.e., the word bank numbers), and word statuses 530. The dictionaries 510 can be, for example, “Chinese-English Dictionary” and “Chinese-Japanese Dictionary.” The dictionary numbers 520 are, for example, “113” and “124.” The word statuses 530 are, for example, “5” and “3.” After the user starts the translating dictionary program, it sends out an updating command. The translating dictionary user end 410 receives the updating command. According to the updating list defined by the user in advance, such as the “Chinese-English Dictionary” and the “Chinese-Japanese Dictionary,” translating dictionary user end 410 reads the word statuses 530 “5” and “3” corresponding to the “Chinese-English Dictionary” and the “Chinese-Japanese Dictionary” from the dictionary list 500, respectively. (Step 301)

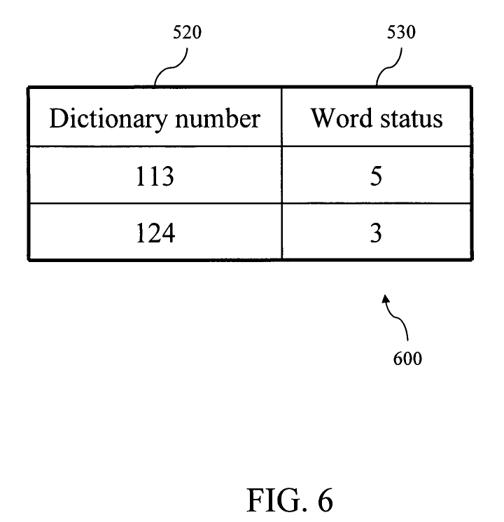

Please refer to FIG. 6. The translating dictionary user end 410 uses the word status 530 “5” of the “Chinese-English Dictionary” and the word status 530 “3” of the “Chinese-Japanese Dictionary” to generate a request list 600. The request list 600 includes the dictionary numbers 520 “113” and the word status 530 “5” corresponding to the “Chinese-English Dictionary” and the dictionary number 520 “124” and the word status 530 “3” corresponding to the “Chinese-Japanese Dictionary.” After the translating dictionary user end 410 obtains the request list 600, it transmits the request list 600 to the translating dictionary server end 420 via the network connection in between. (Step 302)

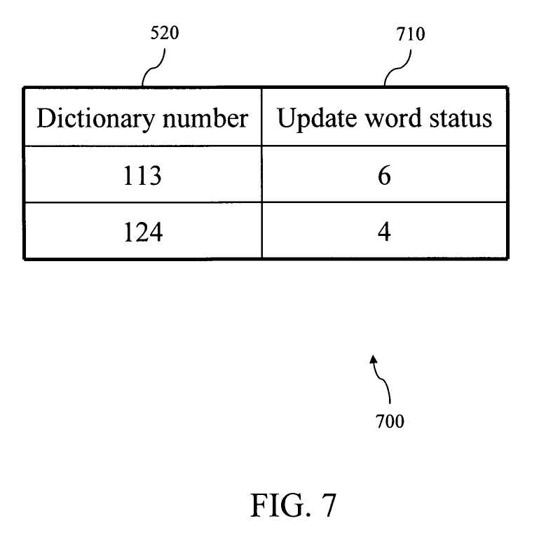

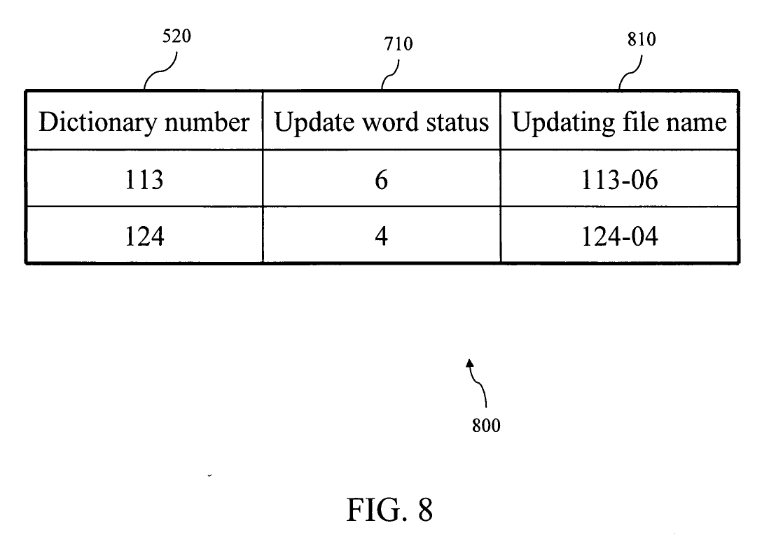

Please refer to FIGS. 7 and 8. The updating data list 700 includes dictionary numbers 520 and update word statuses 710. After the translating dictionary server end 420 receives the request list 600, the dictionary number 520 “113” and word status 530 “5”, the dictionary number 520 “124” and word status 530 “3” in the request list 600 are compared with the dictionary number 520 “113” and update word status 710 “6”, the dictionary number 520 “124” and update word status 710 “4” in the updating data list 700 to obtain the extracting list 800. The extracting list 800 includes dictionary numbers 520, update word statuses 710, and updating file names 810. For example, the dictionary number 520 “113” has the update word status 710 “6” and the updating file name 810 “113-06.” The dictionary number 520 “124” has the update word status 710 “4” and the updating file name 810 “124-04.” (Step 303)

The translating dictionary server end 420 follows the updating file name 810 “113-06” of the dictionary number 520 “113” and the updating file name 810 “124-04” of the dictionary number 520 “124” in the extracting list 800 to extract updating data. The translating dictionary server end 420 then obtains the updating files “113-06” and “124-04.” The updating file “113-06” has the dictionary number 520 “113” and the update word status 710 “6”. The updating file “124-04” has the dictionary number 520 “124” and the update word status 710 “4.” (Step 304)

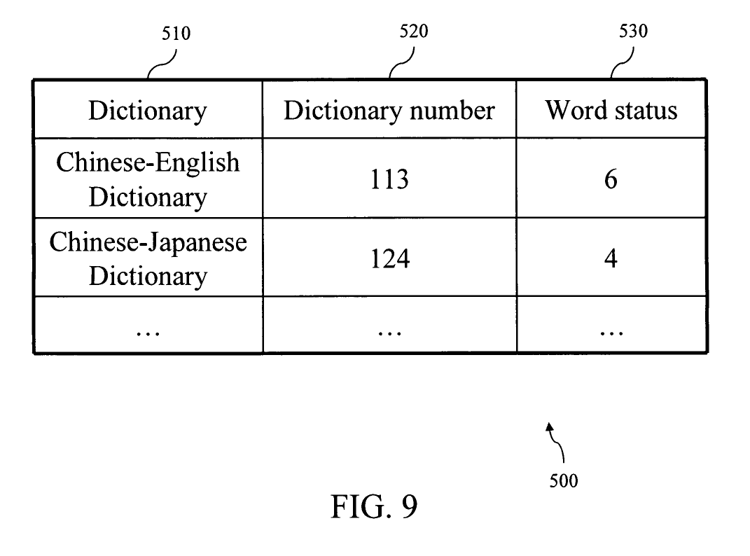

Please refer to FIG. 9. The translating dictionary server end 420 transmits the updating files “113-06” and “124-04” to the translating dictionary user end 410 via the network connection (Step 305). After the translating dictionary user end 410 receives the updating files “113-06” and “124-04”, it updates the “Chinese-English Dictionary” corresponding to the dictionary number 520 “113” according to the updating file “113-06” and updates the “Chinese-Japanese Dictionary” corresponding to the dictionary number 520 “124” according to the updating file “124-04” (Step 306). In the dictionary list 500, the word status 530 “5” of the “Chinese-English Dictionary” is updated to the word status 530 “6” according to the update word status 710 “6”, and the word status 530 “3” of the “Chinese-Japanese Dictionary” is updated to the word status 530 “4” according to the update word status 710 “4.”

In summary, the invention differs from the prior art in that its user end transmits the request list containing the word bank numbers and the corresponding word statuses to the server end. After a comparison, the server end extracts updating files and transmits them to the user end. The user end then updates its word banks. This technique can prevent the ambiguity in determining which word bank to update and updating errors. The invention simple uses the word bank numbers and the corresponding rod statuses to update the word banks, without the trouble of being unable to update due to same language.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A word bank updating system, comprising:
a user end, which includes:
a first receiving module for receiving an updating command and at least one updating file;
a reading module for reading at least a word status corresponding to one word bank according to an updating list after receiving the updating command;
a generating module for generating a request list from the word statuses of the word banks, the request list containing word bank numbers and the corresponding word statuses;
a first transmitting module for transmitting the request list; and
an updating module for updating the updating files to the corresponding word banks according to the word bank numbers after receiving the updating files; and
a server end, which includes:
a second receiving module for receiving the request list transmitted from the user end;
a comparing module for obtaining an extracting list by comparing the request list with an updating data list that has the word bank numbers and corresponding update word statuses;
an extracting module for extracting updating data according to the extracting list, thereby obtaining at least one updating file containing the word bank number and the update word status; and
a second transmitting module for transmitting the updating files to the user end.

2. The word bank updating system of claim 1, wherein the updating list is defined by the user or by the system default about which word banks to update.

3. The word bank updating system of claim 1, wherein the request list further includes a serial number.

4. The word bank updating system of claim 3, wherein the server end further includes a verifying module for verifying the serial number.

5. The word bank updating system of claim 1, wherein the updating module updates the update word statuses to the corresponding word statuses according to the word bank numbers.

6. The word bank updating system of claim 1, wherein the comparing module compares the word statuses in the request list and the update word statuses in the updating data list.

7. A word bank updating method comprising the steps of:
reading at least a word status corresponding to one word bank according to an updating list after a user end receives an updating command;
generating a request list from the word statuses of the word banks by the user end and transmitting it to a server end, the request list containing word bank numbers and the corresponding word statuses;
comparing the request list with an updating data list to obtain an extracting list at the server end, the updating data list including the word bank numbers and the corresponding word statuses;
extracting updating data according to the extracting list to obtain at least one updating file, each of which has the word bank number and the update word status;
transmitting the updating files from the server end to the user end; and
updating the updating files to the corresponding word banks according to the word bank numbers at the user end.

8. The word bank updating method of claim 7, wherein the updating list is defined by the user or by the system default about which word banks to update.

9. The word bank updating method of claim 7, wherein the request list further includes a serial number.

10. The word bank updating method of claim 9 further comprising the step of verifying the serial number.

11. The word bank updating method of claim 7 further comprising the step of updating the update word statuses to the corresponding word statuses according to the word bank numbers.

12. The word bank updating method of claim 7, wherein the step of obtaining the extracting list is done by comparing the word statuses in the request list and the update word statuses in the updating data list.
